(19) United States
(12) Patent Application Publication
(10) Pub. No.: US 2025/0198005 A1
(43) Pub. Date: Jun. 19, 2025

(54) Method for Coating a Component

(71) Applicant: Ceres Intellectual Property Company Limited, Horsham Sussex (GB)

(72) Inventor: Robert Leah, Horsham Sussex (GB)

(21) Appl. No.: 18/846,610

(22) PCT Filed: Mar. 17, 2023
(86) PCT No.: PCT/GB2023/050654

§ 371 Date: Sep. 12, 2024

(30) Foreign Application Priority Data
Mar. 17, 2022 (GB) 2203718.8
Mar. 17, 2022 (GB) 2203721.2

(51) Int. Cl. C23C 18/12; C25B 9/60; H01M 8/021; H01M 8/0215; H01M 8/0228; H01M 8/12; H01M 8/2465

(52) U.S. Cl. CPC C23C 18/1216; C23C 18/1225; C23C 18/1241; C23C 18/1254; H01M 8/021; H01M 8/0215; H01M 8/0228; H01M 8/2465; C25B 9/60; H01M 2008/1293

(57) ABSTRACT

A method for producing a coated chromium-containing component includes providing a coating mixture of a solvent and a source of praseodymium and/or a source of terbium, contacting the surface of the component with the coating mixture, optionally drying, and heating the component in an oxidising atmosphere at a temperature of 450° C. or higher. Examples include coated components for a device, and electrochemical devices with coated components, the components having a surface coating including at least one layer that includes a praseodymium material and/or terbium material. The method produces coatings that reduce chromium evaporation and are useful as barriers on a chromium-containing components.

### CROSS REFERENCE TO RELATED APPLICATIONS

This application is a § 371 national stage of international application no. PCT/GB2023/050654, filed on Mar. 17, 2023, which claims priority to UK application 2203718.8, filed on Mar. 17, 2022, and claims priority to UK application 2203721.2, filed on Mar. 17, 2022, the contents of all of which are hereby incorporated by reference herein.

### FIELD

The present invention relates to methods for producing coated components, to coated components for use in devices and to electrochemical devices comprising coated components.

### BACKGROUND

Coatings based on rare earth compounds have been used to reduce corrosion of, and to provide specific surface properties to, substrates.

Yan Yan et al. (Surface and Coatings Technology; Vol. 272, (2015), pp. 415-427) discloses fabrication of lanthanum, yttrium and cerium oxide coatings on porous stainless steel for use in metal-supported solid oxide fuel cells. The paper explains that the suitability of rare earth oxides as coatings is highly dependent on which rare earth oxide is used.

US-A-2004/186201 discloses corrosion resistant coatings (including carbon pigments) for substrates that may contain rare earths. US-A-2005/0061664 discloses electrolysers and, more specifically, interconnect supported electrolyser assemblies, preforms and methods of fabrication. ES 2359550 discloses vitreous coating compositions and methods for obtaining vitreous coatings, obtained by means of a sol-gel process, which are stable at temperatures of up to 250° C. KR 1020200131553 discloses an interconnector for a solid oxide battery having a PrₓO_{2x-δ} coating. KR 1020200132500 discloses a battery module.

WO-A-05/071021 discloses corrosion inhibiting coating compositions as self-priming topcoats that contain fluorinated resins and may include corrosion-inhibiting rare earth compounds.

US-A-2013/251942 and WO-A-2012/021822 each disclose a substrate with a hydrophobic coating of a rare earth element material (oxide, carbide, nitride, fluoride and/or boride) having a dynamic water contact angle of at least about 90 degrees.

Fontana et al. (Journal of Power Sources 171 (2007) pp. 652-662) disclose corrosion resistance and conductivity evaluation studies on alloys using La, Y and Nd oxide coatings deposited by metal organic chemical vapour deposition.

Electrochemical cells formed of oxide layers (often known as solid oxide cells: SOC) that may include rare earth oxide layers may be used as fuel cells or electrolyser cells.

SOC fuel cell units produce electricity using an electrochemical conversion process that oxidises fuel. SOC fuel cell units can also, or instead, operate as regenerative fuel cells (or reverse fuel cells) units, often known as solid oxide electrolyser fuel cell units, for example to separate hydrogen and oxygen from water, or carbon monoxide and oxygen from carbon dioxide.

A solid oxide fuel cell (SOFC) generates electrical energy through the electrochemical oxidation of a fuel gas (usually hydrogen-based) and the device is generally ceramic-based, using an oxygen-ion conducting metal-oxide containing ceramic as its electrolyte. Many ceramic oxygen ion conductors (for instance, doped zirconium oxide or doped cerium oxide) have useful ion conductivities at temperatures in excess of 450° C. or 500° C. (for cerium-oxide based electrolytes) or 650° C. (for zirconium oxide-based ceramics), so SOFCs tend to operate at elevated temperatures. The fuel electrode, electrolyte and air electrode of an SOC may each be formed of one or more layers to optimise operation.

In operation, the electrolyte of the SOFC conducts oxygen ions from a cathode to an anode located on opposite sides of the electrolyte. A fuel contacts the anode (usually known as the “fuel electrode”) and an oxidant, such as air or an oxygen rich fluid, contacts the cathode (usually known as the “air electrode”). Conventional ceramic-supported (e.g. anode-supported) SOFCs have low mechanical strength and are vulnerable to fracture. Hence, metal-supported SOFCs have since been developed which have the active fuel cell component layers supported on a metal substrate. In these cells, the ceramic layers can be very thin since they only perform an electrochemical function: that is to say, the ceramic layers are not self-supporting but rather are thin coatings/films laid down on and supported by the metal substrate. Such metal supported SOFC stacks are more robust, lower cost, have better thermal properties than ceramic-supported SOFCs and can be sealed using conventional metal welding techniques.

Applicant's WO-A-2015/136295 discloses metal-supported SOFCs in which the metal support plate has a porous region surrounded by a non-porous region with the active layers being deposited upon the porous region so that gases may pass through the pores from one side of the metal support plate to the opposite side to access the active layers coated thereon. The porous region comprises small apertures (holes drilled through the metal foil substrate) extending through the support plate.

WO-A-2016/128721 discloses an interconnect for a low temperature solid oxide fuel cell, in particular to an interconnect comprising a chromium oxide layer (chromium(III) oxide/chromia).

Components including metal supports and interconnects and other components in SOFCs (and other devices) may be formed of SOFC-specific materials including steels. There is a desire, however, to use materials containing chromium, that may be lower cost or may have other beneficial properties. It has, however, been observed that materials (for example metal alloys) may exhibit chromium volatility. Volatile chromium compounds may cause problems during manufacture and may poison SOFC electrodes during operation. There have been attempts to coat components (e.g. with alumina or CoCe) to reduce the chromium problem but these are not wholly successful.

There is a need, therefore, to reduce or prevent problems associated with the use of chromium containing materials.

It is an aim of the present invention to address this need.

### SUMMARY

The present invention accordingly provides, in a first aspect, a method of producing a coated component, the method comprising: a) providing a chromium-containing component, b) providing a coating mixture comprising at least one solvent, and a source of praseodymium and/or a source of terbium, c) contacting at least one surface of the component with the coating mixture, d) optionally drying the component, and e) heating the component in an oxidising atmosphere at a temperature of 450° C. or higher.

Consequently, in the method where a source of praseodymium is used, there is provided a method for producing a coated component, the method comprising: a) providing a chromium-containing component, b) providing a coating mixture comprising at least one solvent, and a source of praseodymium, c) contacting at least one surface of the component with the coating mixture, d) optionally drying the component, and e) heating the component in an oxidising atmosphere at a temperature of 450° C. or higher.

Such a method is advantageous because the method thereby produces a chromium-containing component having at least one surface coated with a coating comprising at least one layer comprising a Pr or Tb material, which has been observed to surprisingly reduce problems with chromium containing components.

The coating has the advantage that it may act as a barrier reducing or preventing chromium volatility.

The heating step may be a step for decomposition of the source of Pr and/or source of Tb coating, and also oxidation of the coating to produce the coating with properties of the barrier layer in a single heating step. Alternatively, the method may further comprise one or more additional heating steps, optionally in an oxidising atmosphere. Thus, the method may further comprise additionally heating the component at a temperature of 450° C. to 950° C., optionally 450° C. to 910° C., optionally 450° C. to 870° C., optionally 450° C. to 810° C., optionally 450° C. to 620° C. The additional heating step may occur during operation of the component.

The source of praseodymium and/or the source of terbium may be a source of Pr(III) and/or Tb(III). Usually, the source of praseodymium and/or the source of terbium may be a source of Pr(III) or Tb(III) thereby producing a coating comprising a Pr or Tb containing material. In some applications, however, the source of praseodymium and/or a source of terbium may be a mixed source of praseodymium and terbium thereby producing a mixed material comprising both Pr and Tb.

The method may further comprise repeating steps a) to c), and optionally d) and e), thereby producing a coated component having a coating comprising a plurality of layers. This is advantageous if a thicker coating is desired.

The method according to the invention is advantageous because it allows the coating to be continuous (e.g. to form a substantially uninterrupted coating). Furthermore, it has been discovered that the coating may be electrically conductive.

Generally, the coating may have a thickness in the range 50 nm to 1 μm, preferably the coating has a thickness in the range 50 nm to 500 nm, more preferably 50 nm to 200 nm.

The component may otherwise be uncoated i.e. the coating may be located directly on the surface of the component with no intervening layers.

The component may comprise a metallic alloy comprising chromium. Such alloys may be selected from a Ni and/or Co superalloy.

The alloy will usually comprise a ferrous (i.e. iron containing) alloy comprising chromium.

The component may comprise stainless steel, e.g. ferritic stainless steel.

The alloy may comprise 11% wt Cr or greater; optionally 15% wt Cr or greater; optionally 17% wt Cr or greater; optionally 19% wt Cr or greater.

The alloy may have amounts of lanthanum or zirconium lower than 0.08 wt %.

Preferably, the coating mixture is in the liquid state, and preferably comprises a coating solution.

The solvent may comprise an alcohol, optionally a C₁ to C₆ alcohol. The solvent may be selected from one or more of ethanol, propanol, and/or methoxypropanol.

Liquid coating methods may be used. For example, contacting at least one surface of the component with the coating mixture may comprise dip coating the component in the coating mixture and/or spray coating the component with the coating mixture.

If the method comprises dip coating, dip coating the component may be performed at a controlled dip rate to aid control of the thickness and other characteristics of the coating.

If the method is spraying, the method may comprise atomised spraying, optionally using a sonic atomiser or an ultrasonic atomiser.

Contacting at least one surface of the component with the coating mixture may be undertaken at a component temperature in the range 10° C. to 100° C., optionally at 12° C. to 50° C., optionally at around room temperature.

The surface of the component may be cleaned/polished before contacting the surface of the component with the coating mixture.

Heating the component in an oxidising atmosphere may comprise heating the component to a temperature of 480° C. or higher, optionally 500° C. or higher, optionally to a temperature of 520° C. or higher, optionally 550° C. or higher.

Heating the component in an oxidising atmosphere may comprise heating the component to a temperature of 580° C., 610° C., 650° C., 670° C., 720° C., 770° C., 820° C., 870° C., 900° C., 910° C. or higher.

The oxidising atmosphere may comprise oxygen and may usually comprise air.

The source of praseodymium and/or the source of terbium may comprise a Pr(III) salt and/or a Tb(III) salt. The salts may usually be Pr(III) nitrate and/or Tb(III) nitrate.

The source of praseodymium and/or a source of terbium may comprise chelated Pr (III) and/or chelated Tb(III). Optionally, the chelated Pr(III) and/or chelated Tb(III) may comprise a bidentate ligand (e.g. acetylacetonate (acac) or ethylenediamine) or a tridentate or tetradentate ligand.

The source of praseodymium and/or a source of terbium may comprise a mixture of a Pr(III) salt and chelated Pr(III); and/or a mixture of a Tb(III) salt and chelated Tb(III).

Thus, the source of Pr(III) may comprise chelated Pr(III) and/or the source of Tb(III) may comprise chelated Tb(III).

The method according to the first aspect produces a coated component that may have various uses. Thus, the coated component may comprise a coated component for use in a device, optionally for operation at a temperature of 450° C. or higher.

In a second aspect, the invention may provide a coated component being obtainable by a method as set out above.

In a third aspect, the present invention accordingly provides a coated component for a device, the coated component comprising a chromium-containing component, the component having at least one surface bearing a coating comprising at least one layer comprising a praseodymium material and/or terbium material.

Thus, where the coating comprises at least one layer comprising a praseodymium material, there is provided a coated component for a device, the coated component comprising a chromium-containing component, the component having at least one surface bearing a coating comprising at least one layer comprising a praseodymium material.

Preferably, the device is for operation at a temperature of 450° C. or higher. The coating may comprise two or more layers, each layer comprising a praseodymium material and/or a terbium material. The coating may comprise three or more layers, each layer comprising praseodymium material and/or terbium material.

Optionally, the coating may be in direct contact with (i.e. directly adjoining) the metal surface of the component. Thus, the coating may be on a bare or otherwise uncoated surface of the component.

Coatings as described herein may form barrier coatings on chromium-containing components reducing or preventing chromium volatility and acting to protect components that may be susceptible to chromium contamination especially when those susceptible components are in fluid communication with the chromium-containing components, e.g. in a system comprising a stack of electrochemical cells.

In one preferred aspect, the device may comprise an electrochemical cell. The component thus may comprise an interconnect, a spacer, a metal plate or a substrate.

The device may be a system comprising a stack of electrochemical cells. The component may thus comprise a system component, for example a pipe fitting, a fastening, a valve component, a pipe or a heat exchanger.

In a fourth aspect, the present invention accordingly provides an electrochemical device comprising a coated component, the coated component comprising a chromium-containing component with at least one surface bearing a coating comprising at least one layer comprising a praseodymium material and/or a terbium material.

Thus, where the coating comprises at least one layer comprising a praseodymium material, there is provided an electrochemical device comprising a coated component, the coated component comprising a chromium-containing component with at least one surface bearing a coating comprising at least one layer comprising a praseodymium material.

The electrochemical device may be a system comprising a stack of electrochemical cells.

The electrochemical device may be (or comprise) an electrolytic cell, an oxygen separator, a sensor or a fuel cell, preferably a SOFC. Preferably, the electrochemical cell is for operation at a temperature of 450° C. or higher.

In all the aspects of the invention, relating to the method, to the coated component, to the electrochemical device and to the use, preferably the coating is not an active electrochemical layer e.g. not an electrode or electrolyte layer.

The coating acts as barrier coating on the component reducing or preventing chromium volatility.

Thus in a fifth aspect there is provided the use of a coating as a barrier coating on a chromium-containing component in an electrochemical device wherein the coating comprises at least one layer comprising a praseodymium material and/or a terbium material.

Thus, where the coating comprises at least one layer comprising a praseodymium material, there is provided the use of a coating as a barrier coating on a chromium-containing component in an electrochemical device wherein the coating comprises at least one layer comprising a praseodymium material.

Preferably, the coating is adjacent the surface of the component i.e. is located directly on the component surface.

The invention in its various aspects is advantageous because it may protect substrates, components and devices (including electrochemical cells) from contamination by chromium that may otherwise evaporate from components (including stainless steel components) at higher temperature and which may otherwise react to form a stable chromate phase over the active surface of the components (e.g. over electrodes in electrochemical cells).

### Definitions

In this specification, the term “source of” an element, compound or other material refers to a material comprising the element, compound or other material whether or not chemically bonded in the source. The source of the element, compound or other material may be an elemental source (e.g. Pr, Tb or O₂) or may be in the form of a compound or mixture comprising the element, compound or other material including one or more of those elements, compounds or materials.

In this specification, references to a source of praseodymium and/or a source of terbium may refer to a source of praseodymium or a source of terbium; or may refer to a source of praseodymium and a source of terbium (e.g. a mixture of a source of praseodymium and a source of terbium). Similarly, in this specification references to a praseodymium material and/or a terbium material may refer to a praseodymium material or a terbium material; or may refer to a praseodymium material and a terbium material (e.g. a mixture of a praseodymium material and a terbium material).

In this specification references to electrochemical cell, SOC, SOFC and SOEC may refer to tubular or planar cells. Electrochemical cell units may be tubular or planar in configuration. Planar fuel cell units may be arranged overlying one another in a stack arrangement, for example 100-200 fuel cell units in a stack, with the individual fuel cell units arranged electrically in series.

Electrochemical cells may be fuel cells, reversible fuel cells or electrolyser cells. Generally, these cells may have the same structure and reference to electrochemical cells may refer (unless the context suggests otherwise) to any of these types of cell. The cell may be based upon a solid oxide electrolyte, optionally a metal-supported solid oxide cell. In fuel cell mode, a fuel contacts the anode (fuel electrode) and an oxidant, such as air or an oxygen-rich fluid, contacts the cathode (air electrode), so in fuel cell mode operation, the air electrode will be the cathode. A solid oxide electrolyser cell (SOEC) may have the same structure as an SOFC, but is essentially the SOFC operating in reverse, or in a regenerative mode, to achieve the electrolysis of water and/or carbon dioxide by using the solid oxide electrolyte to produce hydrogen gas and/or carbon monoxide and oxygen.

In this specification, Area Specific Resistance (ASR; units of Ωcm² or mΩcm² when not normalised) refers to the internal resistance of an electrochemical cell normalised to the cell active area (commonly used to allow direct comparison of cells of different active areas). ASR is equivalent to the voltage drop due to the internal cell resistance when multiplied by the current density (in Acm⁻²)

Secant ASR is derived from the voltage drop from open circuit to the cell operating voltage divided by the applied current density (so a cell of lower ASR will have a higher operating voltage and power output at any given applied current density).

Ohmic/series resistance (Rs) is the component of the cell internal resistance with no associated capacitance (resistance of the oxide scales of steel components may be described by Rs).

The term “fluid flow path” is used to define fluid flow paths between various components, and thus it is also to be understood that those components are in fluid flow communication with one another.

The various features of aspects of the disclosure as described herein may be used in combination with any other feature in the same or other aspect of the disclosure, if needed with appropriate modification, as would be understood by the person skilled in the art.

Furthermore, although all aspects of the invention or disclosure preferably “comprise” the features described in relation to that aspect, it is specifically envisaged that they may “consist” or “consist essentially” of those features outlined in the claims.

The invention will now be described with reference to the accompanying figures and examples.

### BRIEF DESCRIPTION OF THE FIGURES

FIG. 1 shows a graph of normalised series resistance as a function of temperature for coated stainless steel interconnects.

FIG. 2 shows a graph of secant ASR as a function of temperature normalised to standard SOFC cells for stainless steel (with 22-23% Cr and 0.1% La) SOFC substrates coated according to the invention.

FIG. 3 shows a graph of Rs as a function of temperature normalised to the standard SOFC cells for stainless steel SOFC substrates coated as for FIG. 2.

FIG. 4 shows a graph SecASR as a function of temperature normalised to the standard SOFC cells for stainless steel SOFC substrates coated as for FIG. 2.

FIG. 5 shows a schematic flow diagram of the method.

FIG. 6 shows a schematic of a fuel cell system illustrating fluid flow paths.

FIG. 7 shows a schematic (not to scale) cross section of a coated component.

FIG. 8 shows a graph of cumulative chromium evaporation from coated stainless steel coupons as a function of time.

### DETAILED DESCRIPTION

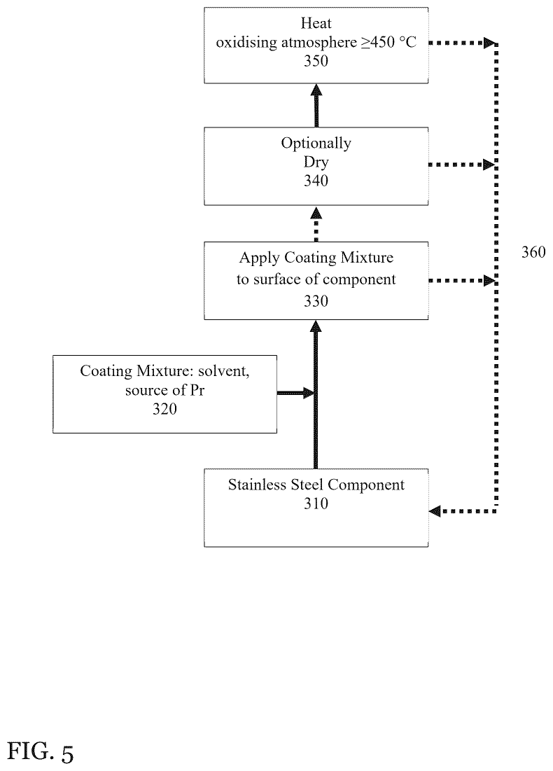

FIG. 5 shows a schematic flow diagram illustrating the method of providing the coating on a component as in the Examples. In FIG. 5, dashed arrows indicate optional steps. A coating mixture 320 containing solvent, and a source of Pr, such as, for example, a mixture of Pr nitrate and Pr acac is provided. The coating mixture 320 is applied in step 330 to the component (which may be of stainless steel) 310. After applying 330 the coating mixture 320, the component is optionally dried 340 and then heated 350 in an oxidising atmosphere at 450° C. or above. Optionally, the coating steps are repeated 360 after the step 330, after the optional drying step 340 or after the heating step 350 to form further layers and a thicker coating.

Chromium contamination may affect electrochemically active components in fuel cell systems, especially where chromium-containing components are in fluid flow communication with electrochemically active components. Coatings as described herein may form barrier coatings on chromium-containing components reducing or preventing chromium volatility and acting to protect components (e.g. that are in fluid communication with the chromium-containing components) that may be susceptible to chromium contamination.

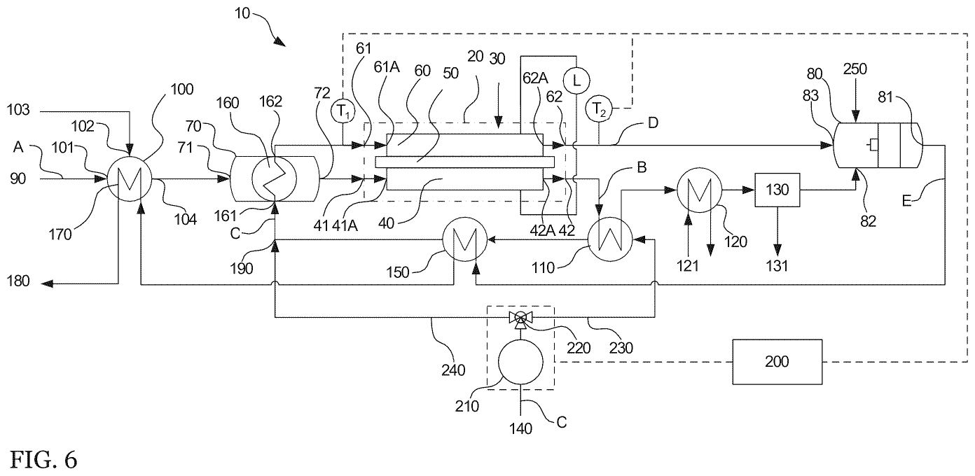

Thus, referring to FIG. 6, fuel cell system 10 is an intermediate-temperature solid oxide fuel cell(IT-SOFC) system. Fuel cell stack 20 is a metal-supported IT-SOFC fuel cell stack, as taught in WO-A-2015/004419. Fuel cell system 10 has a steady state 1 kW electric output from fuel cell stack 20, and comprises 121 metal-supported IT-SOFC fuel cells 30. Each fuel cell 30 has an anode side 40, electrolyte layer 50, and cathode side 60. Each fuel cell layer in the fuel cell stack is separated by an electrically conducting gas impermeable metal interconnect plate (interconnector) (not shown). Fuel cell stack endplates and compression means (not shown) are also provided.

Reference herein to fuel cell 30 is to the full set of 121 fuel cells 30.

Electrical load L is placed across fuel cell 30.

Fuel cell stack anode inlet 41 is in fluid flow communication with fuel cell anode inlet 41A for the flow of anode inlet gas to the anode side 40 of fuel cell 30. Fuel cell anode outlet 42A is in fluid flow communication with fuel cell stack anode off-gas outlet 42 for the flow of anode off-gas.

Fuel cell stack cathode inlet 61 is in fluid flow communication with fuel cell cathode inlet 61A for the flow of cathode inlet gas to the cathode side 60 of fuel cell 30. Fuel cell cathode outlet 62A is in fluid flow communication with fuel cell stack cathode off-gas outlet 62 for the flow of cathode off-gas.

Steam reformer 70 comprises reformer inlet 71 for anode inlet gas and reformer outlet 72 for exhausting anode inlet gas.

Tail-gas burner 80 is in fluid flow communication with fuel cell stack anode and cathode off-gas outlets 42, 62 and has a tail gas burner exhaust 81, anode off-gas inlet 82 and cathode off-gas inlet 83. Tail-gas burner 80 defines a fluid flow path from fuel cell stack anode and cathode off-gas outlets 42, 62 to tail-gas burner exhaust 81, and is configured for burning anode and cathode off-gases and producing a tail-gas burner off-gas.

An anode inlet gas fluid flow path A is defined from fuel source 90 to evaporator 100 to steam reformer 70 to fuel cell stack anode inlet 41 to fuel cell anode inlet 41A, i.e. the components are in fluid flow communication with one another.

An anode off-gas fluid flow path B is defined from fuel cell anode outlet 42A to fuel cell stack anode off-gas outlet 42 to anode off-gas heat exchanger 110 (HX-AOG) to condenser heat exchanger 120 to separator 130 to anode off-gas inlet 82 of tail-gas burner 80.

Main cathode inlet gas flow path 230 and air bypass inlet gas flow path 240 have a number of common components and share a common flow path in a number of places, marked as cathode inlet gas fluid flow path C.

Main cathode inlet gas flow path 230 is defined from oxidant inlet 140 to blower 210 to valve/separator 220 to anode off-gas heat exchanger 110 to air pre-heater heat exchanger 150 (HX-APH) to reformer heat exchanger 160 (HX-Ref) to fuel cell stack cathode inlet 61 to fuel cell cathode inlet 61A.

Air bypass inlet gas flow path 240 is defined from oxidant inlet 140 to blower 210 to valve/separator 220 to air bypass inlet 190 to reformer heat exchanger 160 to fuel cell stack cathode inlet 61 to fuel cell cathode inlet 61A.

Valve/separator 220 is controlled by control means 200 so as to split the flow of inlet air between main cathode inlet gas flow path 230 and air bypass inlet gas flow path 240.

Thus, the air bypass inlet gas flow path 240 bypasses anode off-gas heat exchanger 110 and air pre-heater heat exchanger 150.

In this embodiment, the common parts of gas flow paths 230 and 240 (cathode inlet gas fluid flow path C) are therefore (a) oxidant inlet 140 to blower 210 to valve/separator 220, and (b) reformer heat exchanger 160 to fuel cell stack cathode inlet 61 to fuel cell cathode inlet 61A.

A cathode off-gas fluid flow path D is defined from fuel cell cathode outlet 62A to fuel cell stack cathode off-gas outlet 62 to cathode off-gas inlet 83 of tail-gas burner 80.

A tail-gas burner off-gas fluid flow path E is defined from tail gas burner exhaust 81 to air pre-heater heat exchanger 150 to evaporator heat exchanger 170 (HX-Evap) to fuel cell system exhaust 180.

Anode off-gas heat exchanger 110 is in fluid flow communication with (i) fuel cell stack anode off-gas outlet 42 (i.e. with fuel cell anode outlet 42A) and tail-gas burner anode off-gas inlet 82, and (ii) oxidant inlet 140 and fuel cell stack cathode inlet 61 (i.e. with fuel cell cathode inlet 61A), and is arranged for exchanging heat between anode off-gas from fuel cell stack 20 and cathode inlet gas to fuel cell stack 20.

Air pre-heater heat exchanger 150 is in fluid flow communication with (i) tail-gas burner exhaust 81 and fuel cell system exhaust 180, and (ii) oxidant inlet 140 and fuel cell stack cathode inlet 61 (i.e. with fuel cell cathode inlet 61A), and is arranged for exchanging heat between tail-gas burner 81 off-gas and cathode inlet gas to fuel cell stack 20.

Reformer heat exchanger 160 is a parallel-flow heat exchanger and is in fluid flow communication with (i) oxidant inlet 140 and fuel cell stack cathode inlet 61 (i.e. with fuel cell cathode inlet 61A), and (ii) fuel source 90 and fuel cell stack anode inlet 41 (i.e. with fuel cell anode inlet 41A), and is arranged for exchanging heat between cathode inlet gas and anode inlet gas.

Evaporator 100 has a fuel inlet 101 for anode inlet gas from fuel source 90, a water inlet 102 for water from water supply 103, and an evaporator exhaust 104 for exhausting anode inlet gas from evaporator 100, and is located in the anode inlet gas fluid flow path between fuel source 90 and steam reformer 70. Evaporator 100 additionally comprises evaporator heat exchanger 170 located in the tail-gas burner off-gas fluid flow path E between air pre-heater heat exchanger 150 and fuel cell system exhaust 180.

Evaporator heat exchanger 170 is in fluid flow communication with (i) tail-gas burner exhaust 81 and fuel cell system exhaust 180, and (ii) fuel source 90 and water supply 103 and fuel cell stack anode inlet 41 (i.e. with fuel cell anode inlet 41A), and is arranged to exchange heat between tail-gas burner off-gas and anode inlet gas and water, generating a steam fuel mix for the anode inlet gas to steam reformer 70.

Condenser heat exchanger 120 is in fluid flow communication with (i) fuel cell stack anode off-gas outlet 42 (i.e. with fuel cell anode outlet 42A) and tail-gas burner anode off-gas inlet 82, and (ii) cooling circuit 121, and is arranged for exchanging heat between anode off-gas from fuel cell stack 20 and a cooling fluid in cooling circuit 121.

Separator 130 is located in the anode off-gas fluid flow path between condenser heat exchanger 120 and tail-gas burner 80, and has a separator condensate outlet 131, and is adapted to separate condensate from the anode off-gas fluid flow path, and exhaust the condensate via the condensate outlet 131.

Control means 200 is connected to fuel cell stack cathode inlet gas temperature sensor T1, fuel cell stack cathode off-gas temperature sensor T2, blower 210 and valve/separator 220. Control means 200 is configured to maintain the temperature determined by temperature sensors T1 and T2 at or about a desired temperature during steady-state operation of the fuel cell system.

Control means 200 is adapted to operate two independent control loops which operate upon the cathode inlet gas passing through the cathode inlet gas fluid flow path C.

In the first control loop, the heating of cathode inlet gas is controlled. In the second control loop, the mass flow rate of cathode inlet gas is controlled.

In use, fuel cell system 10 goes through three phases: start-up, steady state, and shutdown. In the start-up phase, fuel cell stack 20 is cold (or at least below its steady-state operational temperature), and therefore must be heated in order to achieve an operational state. In the steady state phase, fuel cell stack 20 is maintained at operational temperature, as determined by the sensors T1 and T2. Electricity is generated and used by load L across fuel cell 30. Temperatures detected by temperature sensors T1 and T2 will vary, and control means 200 varies the inlet air mass flow rate and the splitting of air between flow paths 230 and 240 accordingly. In the shutdown phase, electrical power is no longer required from fuel cell system 10, and a controlled shutdown sequence is initiated. Power demand from fuel cell stack 20 is reduced to zero and the temperature set point for fuel cell stack air inlet T1 is reduced, while the air flow rate from the blower 210 is increased.

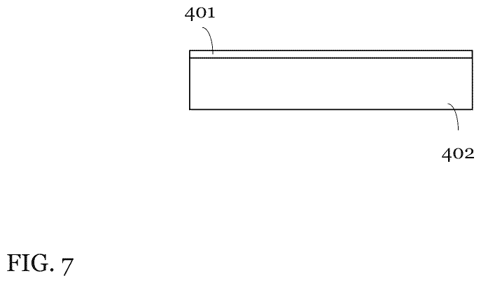

FIG. 7 shows a schematic cross section through a coated component. Component 402 of stainless steel (containing chromium) which may be an interconnect, substrate or other metal component is coated with a coating comprising Pr deposited on the surface of the component using a method as detailed below.

### Examples

In the Examples, components were coated by a sol gel coating technique (dip coating) using a coating solution having a mixture of a rare earth (La or Pr or Tb) salt and chelate (acac).

The coating solution used is a mixture of rare-earth acetylacetonate 75% (Pr or La or Tb) and rare-earth (Pr or La or Tb) nitrate 25% in a 90% vol ethanol/10% vol methoxypropanol mixture.

Metal parts were dip coated in the solution and then hung to allow excess to run off, leaving a thin film of rare earth oxide precursors after drying. This was decomposed to the oxide by heating to >400° C. This deposition process may be repeated one or more times.

After coating, optional drying and decomposition, the metal component was exposed to a high temperature in air to react the coating with the native oxide scale to form the passivating layer.

The metal components used were stainless steel components of Stainless steel with 23% Cr (a stainless steel high in La developed specifically for use in SOFCs), Ferritic stainless steel with 22% Cr, SS441 and SS316.

The Cr compositions of the stainless steels may be:

SS441: Chromium 17.5-18.5%; carbon 0.03%; Si 1.00%; Mn 1.00%; P 0.04%; S 0.015%; Ti 0.1 to 0.6%; niobium (3×C+0.3) to 1.00%; Fe balance.

Ferritic stainless steel with 22% Cr: Chromium 22.1%.

SS316 Chromium 18.2%; molybdenum 2.2%; carbon 0.05%; nickel 10%

Stainless steel with 23% Cr: Chromium 22-23%; including lanthanum 0.1%.

There is a desire to use lower-cost ferritic stainless steels for the substrates of cells. It has however been observed by the inventors that potentially low-cost steels not designed specifically for SOFC application such as the Ferritic stainless steel with 22% Cr have higher chromium volatility at high temperatures. This could cause issues either with cell manufacture or possibly cathode poisoning during operation. It is hypothesised (without wishing to be bound) that this is due to the lack of reactive elements alloying in the steel such as lanthanum or zirconium, which are present in SOFC-specific steels.

The inventors have surprisingly discovered that oxide scale growth and chromium evaporation on the Ferritic stainless steel with 22% Cr can be strongly inhibited during a simulated electrolyte firing by coating the surface with a thin film of praseodymium oxide prior to high temperature oxidation. As discussed above, a solution of praseodymium acetylacetonate and praseodymium nitrate dissolved in a 90:10 ethanol/methoxypropanol solution was used to form a contiguous film by sol gel dip coating, followed by heat treatment to decompose the sol-gel film to the oxide.

In standard SOFC interconnects, a CoCe coating is deposited to suppress corrosion and chromium evaporation.

The inventors have surprisingly discovered that the inventive sol-gel coatings of praseodymium oxide deposited on an otherwise uncoated SS441 interconnect suppress the oxidation of the steel during subsequent heat treatment, and appear to prevent the formation of iron oxide nodules on the surface. It is believed, without wishing to be bound, that these REO coatings may achieve the same result at much lower cost than CoCe coating post-forming, as the REO forms an outer oxide layer of RE chromite/manganite which has a much lower chromium vapour pressure than the native oxide scale. In addition it is expected that the resistance of this protective oxide will be lower than the standard coating, improving performance and possibly reducing degradation.

Furthermore, coating stainless steels such as SS316 with a thin sol-gel coating of rare-earth oxide (e.g. lanthanum oxide or praseodymium oxide or terbium oxide) greatly enhances their resistance to high-temperature corrosion after simply dip coating the component in the solution and allowing it to dry before heat treatment. This is likely to be applicable to balance of stack and balance of plant components, in particular because it is likely to reduce chromium evaporation from surfaces upstream of the stack at a much lower cost and process complexity than aluminising the alloys. In addition this may be more generally applicable in industry (for example automotive exhaust systems or pipework in chemical plants).

### Coating SOFC Interconnects

SOFC interconnects were coated with PrOx and La₂O₃ sol-gel coatings and then fired at 870° C. or 910° C. for 2h in dry air.

The process was as follows:
1) dip coat part in metal-organic solution of rare earth salts in ethanol/methoxypropanol;
2) allow part to dry at room temperature vertically to allow excess solution to run off;
3) heat part to >450° C. to decompose salt coating to the oxide;
4) Repeat as required

The samples made are as indicated in Table 1. Table 1 also indicates durability data for the coatings in terms of voltage degradation rate (in %/kh). The interconnects were tested for 1000 h at 610° C. in a working SOFC stack. Voltage degradation appeared to mostly relate to increases in ohmic resistance of the oxide scale on the interconnects. Lanthanum coatings have higher degradation.

TABLE 1

| | | | | Voltage |
|---|---|---|---|---|
| | Coating | | Firing Temp. | Degradation |
| Sample | Material | Number of Coatings | (° C.) | (%/kh) |
| 1 | PrOₓ | 2 | 870 | −0.87 |
| 2 | PrOₓ | 2 | 910 | −3.24 |
| 3 | PrOₓ | 3 | 910 | −0.75 |
| 4 | La₂O₃ | 2 | 870 | −2.73 |
| 5 | La₂O₃ | 2 | 910 | −8.03 |

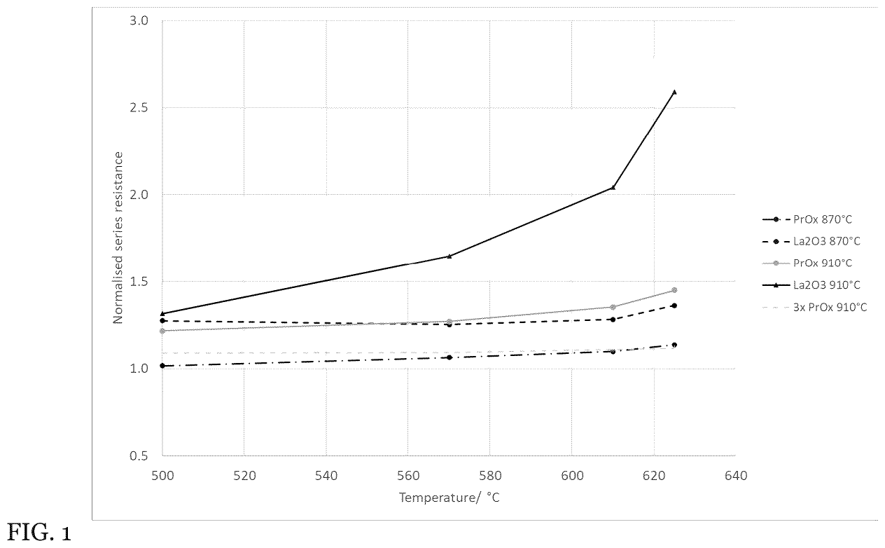

The interconnects were incorporated in a stack of standard SOFC cells and normalised resistance compared to standard cells as a function of temperature determined. The results are shown in FIG. 1.

PrOₓ-coated parts fired at 870° C. have comparable resistance to standard parts; generally parts fired at 910° C. have higher resistance.

La₂O₃-coated parts generally have higher resistance, particularly ones fired at 910° C.

### Coating SOFC Substrates (23% Chromium)

Stainless steel (23% chromium with 0.1% lanthanum) substrates were coated with La₂O₃, or PrOx (double coating with IR heating between stages), or TbOₓ generally as indicated above for the interconnects.

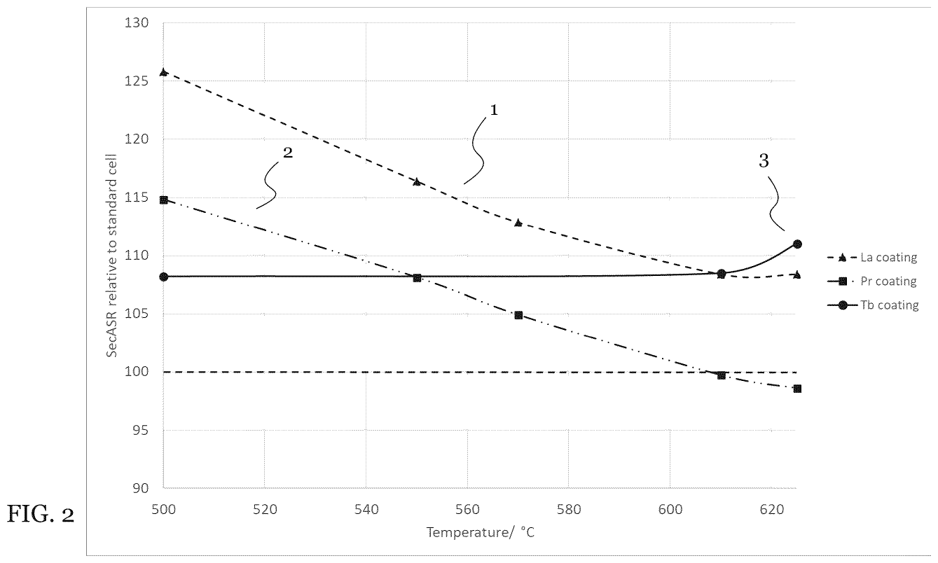

The substrates were incorporated in a stack of standard SOFC cells and performance as a function of temperature determined. The results of the tests are as indicated in FIGS. 2 to 4.

FIG. 2 shows secant ASR as a function of temperature normalised to the standard cells. La₂O₃ coated substrates (curve 1) show higher resistance across the temperature range, PrOₓ-coated substrates (curve 2) have worse performance at low temperatures but comparable or better at >600° C. TbOₓ-coated substrates (curve 3) have good performance. These results are consistent with results on interconnects.

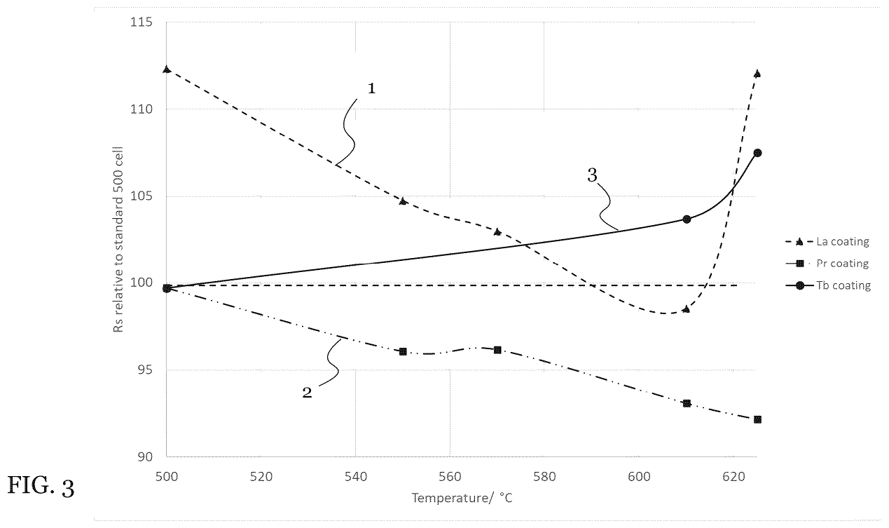

FIG. 3 resistance as a function of temperature normalised to the standard cells.

La₂O₃-coated substrates (curve 1) show an increase in resistance at higher temperatures.

PrOx-coated substrates (curve 2) have lower Rs than the standard cells across the temperature range; the difference increases with increasing temperature.

TbOₓ-coated substrates (curve 3) have generally good performance.

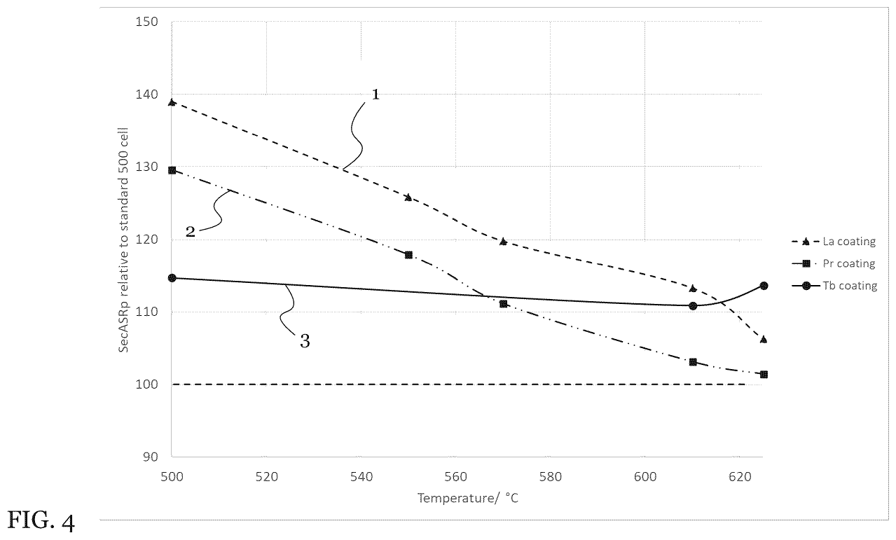

FIG. 4 shows SecASR as a function of temperature normalised to the standard cells. Both La₂O₃-coated substrates (curve 1) and PrOₓ-coated substrates (curve 2) show higher polarisation resistance than the standard cells; TbOₓ-coated substrates (curve 3) have good or very good performance.

It appears that PrOx provides improved results for SOFC applications than La₂O₃ which seems to form a resistive oxide scale. In addition PrOx forms a more stable deposition solution. It is likely that owing to its similar chemistry (Tb forms an electronically conductive mixed valence oxide Tb₄O₇), terbium has generally good performance with similar advantages.

### Coating SOFC Substrates (22% Chromium)

Ferritic stainless steel with 22% chromium substrates were coated with La₂O₃ or PrOx generally as indicated above for the interconnects.

The substrates were incorporated in a stack of standard SOFC cells and ohmic cell resistance normalised to an uncoated substrate (same stainless steel) at 610° C. determined. The PrOx coating result was 0.918 and the La₂O₃ coating 0.921. Thus, coating the substrate results in a reduction of ohmic resistance relative to an uncoated substrate.

### Comparison of Chromium Evaporation Rates.

Measurements of chromium evaporation rate were undertaken using the method described by Froitzheim et al, J. Electrochem. Soc., 157 (9), B1295 (2010) to measure the chromium evaporation from 3 ferritic stainless steel (23% Cr, 0.1% La) coupons. The method involved a denuder tube which was coated with Na₂CO₃ being placed in fluid communication with the samples. CrO₂(OH)₂ that evaporated from the samples was collected on the denuder and converted to the thermally stable Na₂CrO₄. The chromate was then dissolved in water and determined quantitatively.

The samples investigated were:
Uncoated coupon pre-oxidised at 850° C. for 2 hours (h) in air,
La-coated coupon pre-oxidised at 850° C. for 2 h in air,
Pr-coated coupon pre-oxidised at 850° C. for 2h in air

The coatings were applied to the coupons generally as discussed above.

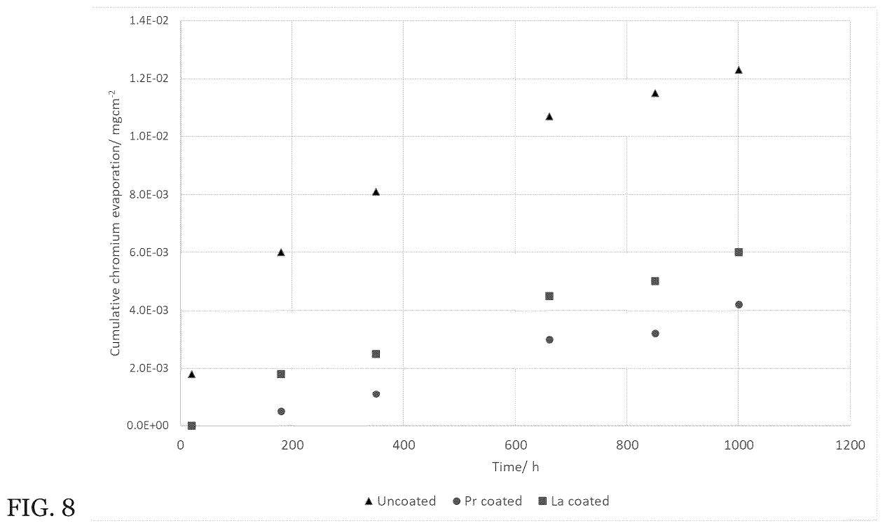

Measurements were undertaken at 600° C. (rather than 850° C. as described in Froitzheim et al.) in flowing air containing 3% water vapour for 1000 h. The results are shown in FIG. 8.

Chromium evaporation from both coated coupons was significantly reduced by comparison with the uncoated coupon, with praseodymium particularly effective.

### Reference Signs

1-curve for La based coating
2-curve for Pr based coating
3-curve for Tb based coating
10-fuel cell system
20-fuel cell stack
30-fuel cell
41-anode side fuel cell stack anode inlet
41A-fuel cell anode inlet
42-fuel cell stack anode off-gas outlet
42A-fuel cell anode outlet
50-electrolyte layer
60-cathode side
61-fuel cell stack cathode inlet
61A-fuel cell cathode inlet
62-fuel cell stack cathode off-gas outlet
62A-fuel cell cathode outlet
70-steam reformer
71-reformer inlet
72-reformer outlet
80-tail-gas burner
81-tail-gas burner exhaust
82-anode off-gas inlet
83-cathode off-gas inlet
90-fuel source
100-evaporator
101-fuel inlet
102-water inlet
103-water supply
104-evaporator exhaust
110-anode off-gas heat exchanger
120-condenser heat exchanger
121-cooling circuit
130-separator
131-separator condensate outlet
140-oxidant inlet
150-air pre-heater heat exchanger
160-reformer heat exchanger
161-reformer heat exchanger oxidant inlet
162-reformer heat exchanger oxidant outlet
170-evaporator heat exchanger
180-fuel cell system exhaust
190-air bypass inlet
200-control means
210-blower
220-valve/separator
230-main cathode inlet gas flow path
240-air bypass inlet gas flow path
250-fuel source
260-air bypass inlet gas flow path
A-anode inlet gas fluid flow path B-anode off-gas fluid flow path
C-cathode inlet gas fluid flow path D-cathode off-gas fluid flow path
E-tail-gas burner off-gas fluid flow path
G-reformer cathode off-gas fluid flow path L-electrical load
T1-fuel cell stack cathode inlet gas temperature sensor
T2-fuel cell stack cathode off-gas temperature sensor
T3-fuel cell stack anode inlet gas temperature sensor
310-stainless steel component
320-coating mixture
330-apply coating mixture
340-(optionally) dry
350-heat
360-(optional) repeat of steps
401-coating comprising Pr
402-stainless steel component

All publications mentioned in the above specification are herein incorporated by reference. Although illustrative embodiments of the invention have been disclosed in detail herein, with reference to the accompanying drawings, it is understood that the invention is not limited to the precise embodiment and that various changes and modifications can be performed therein by one skilled in the art without departing from the scope of the invention as defined by the appended claims and their equivalents.

1. A method for producing a coated component, the method comprising
a) providing a chromium-containing component,
b) providing a coating mixture comprising at least one solvent, and a source of praseodymium and/or a source of terbium,
c) contacting at least one surface of the component with the coating mixture,
d) drying the component, and
e) heating the component in an oxidising atmosphere at a temperature of 450° C. or higher.

2. A method as claimed in claim 1, wherein the source of praseodymium and/or the source of terbium is a source of Pr(III) and/or Tb(III).

3. A method as claimed in claim 2, wherein the source of Pr(III) comprises a Pr(III) salt and/or chelated Pr(III), and/or the source of Tb(III) comprises a Tb(III) salt and/or chelated Tb(III).

4. A method as claimed in claim 1, wherein the method further comprises repeating steps a) to c), thereby producing a coated component having a coating comprising a plurality of layers.

5. A method as claimed in claim 1, wherein the coating is electrically conductive.

6. A method as claimed in claim 1, wherein the coating has a thickness in the range 50 nm to 1 μm, preferably the coating has a thickness in the range 50 nm to 500 nm.

7. A method as claimed in claim 1, wherein the component comprises a metallic alloy comprising chromium.

8-9. (canceled)

10. (canceled)

11. A method as claimed in claim 1, wherein the coating mixture is in the liquid state, and preferably comprises a coating solution.

12. A method as claimed in claim 1, wherein the solvent comprises an alcohol.

13. (canceled)

14. A method as claimed in claim 1, wherein contacting at least one surface of the component with the coating mixture comprises dip coating the component in the coating mixture and/or spray coating the component with the coating mixture.

15. (canceled)

16. A method as claimed in claim 1, wherein the oxidising atmosphere comprises air.

17. (canceled)

18. A coated component for a device, the coated component being obtainable by a method as claimed in claim 1.

19. A coated component for a device, the coated component comprising a chromium-containing component, the component having at least one surface bearing a coating comprising at least one layer comprising a praseodymium material and/or terbium material.

20. A coated component as claimed in claim 19, wherein the device is for operation at a temperature of 450° C. or higher.

21. A coated component as claimed in claim 19, wherein the coating comprises two or more layers, each layer comprising a praseodymium material and/or a terbium material.

22. A coated component for a device as claimed in claim 19, wherein the device comprises an electrochemical cell.

23. A coated component for a device as claimed in claim 22, wherein the component comprises an interconnect, a spacer, a metal plate or a substrate.

24. A coated component for a device as claimed in claim 19, wherein the device comprises a system comprising a stack of electrochemical cells.

25. A coated component for a device as claimed in claim 24, wherein the component comprises a pipe fitting, a fastening, a valve component, a pipe, or a heat exchanger.

26. An electrochemical device comprising a coated component, the coated component comprising a chromium-containing component with at least one surface bearing a coating comprising at least one layer comprising a praseodymium material and/or a terbium material.

27. (canceled)
